(19) United States
(12) Patent Application Publication
(10) Pub. No.: US 2009/0309868 A1
(43) Pub. Date: Dec. 17, 2009

(54) Active matrix organic light emitting diode display and method of driving the same

(75) Inventors: Jisim Jung, Inchon (KR); Woochel Lee, Seoul (KR); Hyunsang Park, Seoul (KR); Sangmyeon Han, Seoul (KR); Minkoo Han, Seoul (KR)

Correspondence Address: HARNESS, DICKEY & PIERCE, P.L.C., P.O. BOX 8910, RESTON, VA, 20195, US

(73) Assignees: Samsung Electronics Co., Ltd.; Seoul National University Industry Foundation

(21) Appl. No.: 12/453,191

(22) Filed: May 1, 2009

(30) Foreign Application Priority Data
Jun. 11, 2008 (KR) 10-2008-0054863

(51) Int. Cl. G09G 5/00; G09G 3/32

(52) U.S. Cl. 345/214; 345/82

(57) ABSTRACT

An active matrix organic light emitting diode (AMOLED) display including an organic light emitting diode (OLED), a driving transistor switching a supply of current to the OLED according to image signals, and at least one current controller including a plurality of current control transistors controlling the amount of the current supplied to the OLED.

### PRIORITY STATEMENT

This application claims priority under 35 U.S.C. § 119 to Korean Patent Application No. 10-2008-0054863, filed on Jun. 11, 2008, in the Korean Intellectual Property Office (KIPO), the entire contents of which is incorporated herein in by reference.

### BACKGROUND

1. Field

An active matrix organic light emitting diode (AMOLED) display and a method of driving the AMOLED display are disclosed.

2. Description of the Related Art

AMOLED displays may have advantages, e.g., fast response speed and wider viewing angle, when compared with liquid crystal displays (LCDs). An AMOLED display may include an organic light emitting diode (OLED) that emits light using electric current in each of a plurality of pixels, and a driver driving the OLED. For example, the driver may include a transistor for switching the pixel, and a driving transistor supplying the current to the OLED.

Each of the pixels in the AMOLED display may include a switching (sampling) transistor sampling analog image signals, a memory capacitor maintaining the image signals, and a driving transistor controlling the current supplied to the OLED based on a voltage of image signals accumulated in the memory capacitor.

In general, channels of the switching transistor and the driving transistor may be formed of amorphous silicon or polycrystalline silicon. Because the switching transistor is a switching device allowing the data voltage to be supplied to the driving transistor, a relatively low leakage voltage and relatively fast response speed may be required. In addition, because the driving transistor supplies the current to the OLED, the driving transistor should reliably transfer high current flows over a long period of time. Although amorphous silicon may more easily realize increased uniformity, voltage stress may degrade amorphous silicon and the threshold voltage may change.

Polycrystalline silicon may have higher mobility and higher optical stability. In addition, voltage stress may degrade polycrystalline silicon less than amorphous silicon, and thus, polycrystalline silicon may have higher reliability than amorphous silicon. An individual skilled in the art may create polycrystalline silicon by crystallizing amorphous silicon. A disadvantage of polycrystalline silicon may be a relatively large off-current caused by a leakage current from a grain boundary. In addition, the uniformity of polycrystalline silicon may be lower than amorphous silicon, and thus, obtaining constant operational characteristics throughout the pixels may be difficult.

In order to compensate for the relatively low uniformity of polycrystalline silicon, various driving methods, e.g., a magnetic compensation voltage programming or a current programming method, have been suggested. However, compensation circuits occupy an effective area in the pixels, and thus, aperture ratio may be reduced and power consumption may increase.

To compensate for the above disadvantages, a driving method that adjusts colors and brightness displayed on a display apparatus by adjusting current flow time in one frame while maintaining a magnitude of the current flowing into the OLED has been suggested in the related art. According to this method, the current flow time, not the magnitude of the current, may be adjusted, and thus, the driving transistor driving the OLED operates in a linear region, and performs as a simple switch. Therefore, the reduced reliability that is caused by the shift of the threshold voltage of the driving transistor and variation between the threshold voltages of the pixels may be reduced or minimized. In addition, compensation circuits requiring several transistors and capacitors need not be required; therefore, reduced aperture ratio caused by compensation circuits does not occur.

According to the driving method described above, the current flow time may be adjusted by dividing one frame into a plurality of sub-frames. For example, in representing a grayscale of 6 bits, six sub-frames may be included in a frame, and each of the sub-frames may be divided into an addressing section and a light emitting section. The number of pixels to be addressed should be increased in order to represent images of high resolution. In addition, the addressing section in the sub-frame should be increased, and as a result, the light emitting time may be reduced or minimized. As described above, increasing the addressing section while holding the time of a frame constant causes the light emitting section to become short, and consequently, the screen becomes dark. In addition, the number of bits should be increased in order to represent a large grayscale, and thus, the number of the sub-frames may increase according to the increase of the bits. Therefore, the entire light emitting time may be reduced causing the screen to become dark.

### SUMMARY

Example embodiments include an active matrix organic light emitting diode (AMOLED) display that may realize grayscale images with high resolution, and a method of driving the same. Example embodiments include an AMOLED display that may realize a bright screen with high grayscale and high resolution, and a method of driving the same.

Example embodiments may be set forth in part in the description which follows and, in part, will be apparent from the description, or may be learned by practice of example embodiments.

Example embodiments may include an active matrix organic light emitting diode (AMOLED) display including: an organic light emitting diode (OLED); a driving transistor to switch a current supplied to the OLED based on image signals; and at least one current controller including a plurality of current control transistors controlling the amount of the current supplied to the OLED.

The AMOLED display may further include: a storage capacitor storing the image signals; and a switching transistor storing the image signals in the storage capacitor. The driving transistor may operate in a linear region, and the plurality of current control transistors may operate in a saturation region.

A fixed bias voltage may be applied to a gate of at least one of the plurality of current control transistors. A dynamic bias voltage may be applied to a gate of at least one of the plurality of current control transistors. A dynamic bias voltage may be applied to a gate of at least one of the plurality of current control transistors.

The at least one current controller may include a first current control transistor to which the fixed gate bias voltage may be applied, and a second current control transistor to which the dynamic gate bias voltage may be applied. The first and second current control transistors may operate in the saturation region, and the driving transistor may operate in the linear region. The AMOLED display may include a storage capacitor storing the image signals, and a switching transistor storing the image signals in the storage capacitor. The switching transistor, the driving transistor, and the first and second current control transistors may include p-type transistors.

Example embodiments may include a method of driving an AMOLED display, the method including: displaying a main frame of an image by representing a plurality of sub-frames chronologically using an OLED in the AMOLED display, wherein the main frame includes a plurality of sub-frames having at least two different brightness levels.

Forming the plurality of sub-frames may include: providing at least one sub-frame of higher brightness; and providing at least one sub-frame of lower brightness to the brightness of the at least one sub-frame of higher brightness, wherein the at least one sub-frame of higher brightness is driven before the at least one sub-frame of lower brightness. The at least two brightness levels are determined by the current of the OLED displaying the plurality of sub-frames in the AMOLED.

Forming the AMOLED display may include: providing a storage capacitor; forming a switching transistor storing image information in the storage capacitor; forming a driving transistor to switch a current supplied to the OLED based on the image information in the storage capacitor; and forming at least one current controller including a plurality of current control transistors controlling the amount of the current supplied to the OLED by the driving transistor.

Representing the plurality of sub-frames may include: recording image information in the storage capacitor by using scan signals and data signals; operating the driving transistor based on the image information in the storage capacitor to turn on/turn off the current flowing through the OLED; and controlling the OLED to emit light by controlling the current flowing through the OLED using a plurality of current control transistors between the driving transistor and the OLED.

The at least one current controller may include a first and a second current control transistor, a fixed gate bias voltage may be applied to a gate of the first current control transistor and a dynamic gate bias voltage may be applied to a gate of the second current control transistor. The first and second current control transistors may operate in a saturation region. The driving transistor may operate in a linear region.

### BRIEF DESCRIPTION OF THE DRAWINGS

Example embodiments will be more clearly understood from the following brief description taken in conjunction with the accompanying drawings. FIGS. 1-5 represent non-limiting, example embodiments as described herein.

FIG. 1 is an equivalent circuit diagram of a unit pixel in an active matrix organic light emitting diode (AMOLED) display according to example embodiments;

FIGS. 2A and 2B are equivalent circuit diagrams showing currents in an OLED of the unit pixel of FIG. 1 according to an operation of the unit pixel shown in FIG. 1, according to example embodiments;

FIG. 3 is a timing diagram for explaining a method of driving the AMOLED display, according to example embodiments;

FIG. 4 is a graph of time versus OLED current for explaining methods of representing a sub-frame in a display of an image, the grayscale of which may be 6 bits and a frame of which may have a period of about 16 ms, according to the related art and example embodiments; and

FIG. 5 is a graph of time versus OLED current for explaining realization of greater grayscale according to the example embodiments in realizing a display of the same brightness and the same resolution in the related art as in example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings may be intended to indicate the presence of a similar or identical element or feature

### DETAILED DESCRIPTION OF EXAMPLE EMBODIMENTS

Example embodiments of an active matrix organic light emitting diode (AMOLED) display and a method of driving the AMOLED display will be described with reference to the accompanying drawings. The AMOLED display according to the example embodiments may include a plurality of data lines and a plurality of scan lines arranged as a matrix in X and Y directions like in related AMOLED's, and pixels may be formed at points of intersection of the data lines and the scan lines. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, e.g., “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein may have the same meaning as commonly understood by one of ordinary skill in the art to which example embodiments belong. It will be further understood that terms, e.g., those defined in commonly-used dictionaries, should be interpreted as having a meaning that is consistent with their meaning in the context of the relevant art and will not be interpreted in an idealized or overly formal sense unless expressly so defined herein.

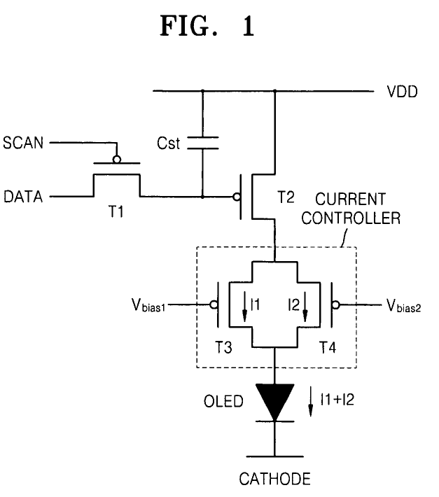

FIG. 1 is an equivalent circuit diagram of a unit pixel in an AMOLED display according to example embodiments. Referring to FIG. 1, the unit pixel may include four p-type transistors T1, T2, T3, and T4 having four p-channels, and a storage capacitor Cst. In the pixel, a gate and a drain of a switching transistor T1 may be connected to a scan line SCAN and a data line DATA, and a source of the switching transistor T1 may be connected to a gate of a driving transistor T2. The switching transistor T1 stores image information in the storage capacitor Cst. The storage capacitor Cst, storing image information of each pixel, may be connected in parallel to the gate and source of the driving transistor T2.

A drain of the driving transistor T2 may be connected to an anode of an organic light emitting diode (OLED) via a current controller. In addition, a CATHODE of the OLED may be a common electrode shared by all of the pixels in the AMOLED display. The current controller may include first and second current control transistors T3 and T4, sources and drains of which may be connected in parallel. The sources of the current control transistors T3 and T4 may be connected to the drain of the driving transistor T2, and the drains of the first and second current control transistors T3 and T4 may be connected to the anode of the OLED.

In the AMOLED display, the driving transistor T2 and the first and second current control transistors T3 and T4 may be between a power supply line VDD and the OLED according to example embodiments. The driving transistor T2 performs as an OLED emitting switch operating in a linear region, and the first and second current control transistors T3 and T4 operate in a saturation region to allow the current, that may be determined by fixed and dynamic bias voltages V_{bias1} and V_{bias2}, to flow between the source and the drain. In example embodiments, the fixed bias voltage V_{bias1} may be applied to the gate of the first current control transistor T3 and the dynamic bias voltage V_{bias2} may be applied to the gate of the second current control transistor T4.

A voltage may be applied to the storage capacitor Cst after selecting a pixel, and the driving transistor T2 may be turned on to supply the electric current to the OLED. A source-drain current I1 flows through the first current control transistor T3 that is in a turn-on status, and the magnitude of the source-drain current I1 may be determined by the gate bias of the first current control transistor T3 that operates in the saturation region. For example, the driving transistor T2 performs as a switch operating in the linear region for turning on/off the OLED, and the first current control transistor T3 performs as a current source, according to example embodiments. In this state, when the dynamic bias voltage V_{bias2} is applied to the gate of the second current control transistor T4, the second current control transistor T4 may be turned on, a source-drain current I2 flows through the second current control transistor T4, and thus, the entire current in the OLED increases.

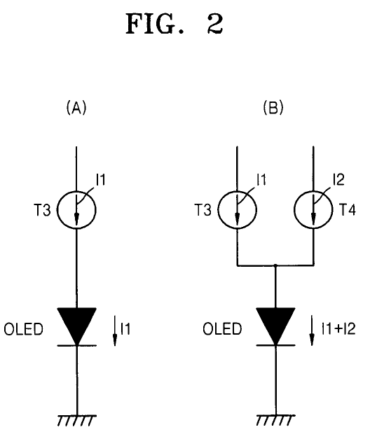

FIGS. 2A and 2B are equivalent circuit diagrams showing the electric current supplied to the OLED from the first and second current control transistors T3 and T4 that may function as current sources. In FIG. 2(A), the state in which the first current control transistor T3 is turned on is shown, and the source-drain current I1 may be supplied to the OLED from the first current control transistor T3. In FIG. 2(B), the first and second current control transistors T3 and T4 may both be turned on, and thus, a relatively large amount of source-drain current (I1+I2) may be supplied to the OLED. As described above, when the amount of current supplied to the OLED is changed by the current controller, the OLED may emit light having a brightness corresponding to the amount of current.

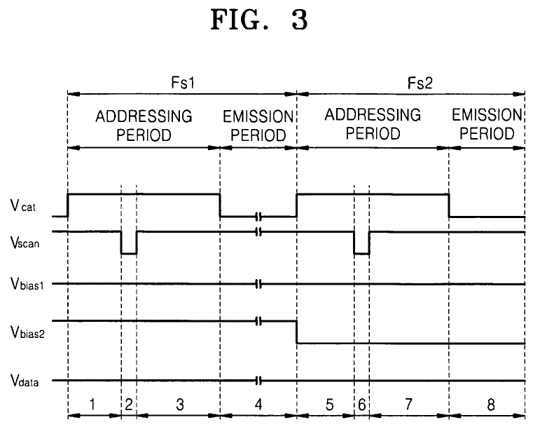

Hereinafter, the AMOLED display and a method of driving the AMOLED display will be described with reference to the following timing diagrams, according to example embodiments. FIG. 3 is a timing diagram showing pixel operation in two sub-frames. In a first sub-frame Fs1, low current may be supplied to the OLED, and in a second sub-frame Fs2, high current may be supplied to the OLED. The above operation may be performed with respect to a n-th pixel under an assumption that light emission may be continuously performed, and a data voltage V_{data} applied to the data line DATA may be constantly applied to the pixel.

Referring to FIG. 3, each of the sub-frames Fs1 and Fs2 may include four sections. In each sub-frame, Fs1 or Fs2, a cathode voltage V_{cat} is logic high and the OLED may be turned off in an addressing period. The cathode voltage V_{cat} is logic low in an emission period to emit the light according to image information (accumulated value) in the storage capacitor Cst. In example embodiments, V_{data} may be constantly applied under the assumption that the pixel emits light continuously, and accordingly, the OLED may be turned on when the driving transistor T2 is turned on by the memory information stored in the storage capacitor Cst.

The table below shows operations of each of the sub-frames Fs1 and Fs2 in each of the sections. Assuming that the fixed gate bias voltage V_{bias1} may be applied to the first current control transistor T3, the first current control transistor T3 maintains the turn-on status.

| | | | | Current | | | | | | |
|---|---|---|---|---|---|---|---|---|---|---|
| Sub- | sec- | | | Source | | | | | | OLED |
| frame | tion | T1 | T2 | T3 | T4 | V_{scan} | V_{cat} | V_{bias2} | OLED | current |
| Fs-1 | 1 | off | off | on | off | high | high | high | off | 0 |
| | 2 | on | on | on | off | low | high | high | off | 0 |
| | 3 | off | on | on | off | high | high | high | off | 0 |
| | 4 | off | on | on | off | N/A | low | high | on | low |
| Fs-2 | 5 | off | off | on | on | high | high | low | off | 0 |
| | 6 | on | on | on | on | low | high | low | off | 0 |
| | 7 | off | on | on | on | high | high | low | off | 0 |
| | 8 | off | on | on | on | N/A | low | low | off | high |

In section 1, the scan signal V_{scan} is logic high, and the cathode voltage V_{cat} of the OLED is logic high. Therefore, the switching transistor T1 and the driving transistor T2 are in turn-off states. Therefore, the current flowing through the OLED may be “0”.

In section 2, an addressing operation on an n-th pixel, for example, programming (memory) of the storage capacitor Cst may be performed. To do this, the scan signal V_{scan} becomes logic low, and the switching transistor T1 and the driving transistor T2 are turned on, and in this state, the cathode voltage V_{cat} maintains the logic high state. Therefore, the current flowing through the OLED may be “0”. The difference between the high level of the cathode voltage and the level of the voltage applied to the anode of the OLED may be equal to or less than a light emitting voltage of the OLED.

In section 3, addressing the pixels after the n-th pixel may be performed, and the scan signal of the n-th pixel may be in a logic high state. In section 4, the OLED emits light according to the image information stored in the storage capacitor Cst, for example, the charge accumulation, and when the cathode voltage V_{cat} becomes logic low, the operating voltage may be applied to the OLED in order for the OLED to emit light. The first current control transistor T3, to which the fixed bias voltage V_{bias1} may be applied, operates in the saturation region, and the source-drain current may be determined by the gate voltage.

In addition, the dynamic bias voltage V_{bias2} need not be applied to the gate of the second current control transistor T4, and thus, the turn-off status of the second current control transistor T4 may be maintained. Therefore, the source-drain current I1, the amount of which may be determined by the first current control transistor T3, flows through the OLED, and the OLED emits light having brightness corresponding to the current value.

The current supply status to the OLED may be represented as FIG. 2(A). Sections 5-8 are for the second sub-frame Fs2. In sections 5-8, the first and second current control transistors T3 and T4 operate, and logic high current may be supplied to the OLED in order for the OLED to emit light of high brightness. The second sub-frame Fs2 will be described in more detail as follows.

In section 5, the scan signal V_{scan} is in a logic high state and the cathode voltage V_{cat} is logic high. Therefore, the switching transistor T1 and the driving transistor T2 may both be turned off. Thus, the current flowing through the OLED may be “0”, and the OLED may be in a turn-off status.

In section 6, an addressing operation of the n-th pixel, for example, programming (memory) of the storage capacitor Cst, may be performed. To do this, when the scan signal V_{scan} assumes a logic low state, the switching transistor T1 and the driving transistor T2 may be turned on, and the cathode voltage V_{cat} maintains the logic high status. Therefore, the current flowing through the OLED may be “0”. Section 7 shows an addressing operation of the pixels after addressing the n-th pixel. The scan signal of the n-th pixel is in a logic high status.

In section 8, the OLED emits light according to the image information of the storage capacitor Cst obtained in the memory process in section 6, for example, the charge accumulation. When the cathode voltage V_{cat} assumes a logic low status, the voltage applied to the OLED increases to the operating voltage in order for the OLED to emit light. The dynamic bias voltage V_{bias2} of the second current control transistor T4 assumes a logic low status, and thus, the second current control transistor T4 may be turned on and a current may be generated between the source and the drain of the second current control transistor T4.

As described above, the first current control transistor T3, to which the fixed gate voltage V_{bias1} is applied, and the second current control transistor T4 operate in the saturation region, and the source-drain currents I1 and I2 may be determined by the corresponding fixed and dynamic bias voltages V_{bias1} and V_{bias2}. When the dynamic bias voltage V_{bias2} of the second current transistor T4 is equal to the fixed bias voltage V_{bias1} of the first current transistor T3, the source-drain current I2 of the second current control transistor T4 may be the same as the source-drain current I1 of the first current control transistor T3. Therefore, the current supplied to the OLED in the second sub-frame Fs2 may be twice that of the first sub-frame Fs1, and thus, the OLED may emit light of higher brightness than that of the first sub-frame Fs1. The current supply status to the OLED may be represented as FIG. 2(B).

In the above description, two sub-frames are described; however, the brightness of the OLED may be adjusted as described above in more sub-frames. Lengths of the sub-frames may be different from each other, for example, the previous sub-frame may be longer than the next sub-frame, and for example, the lengths of the sub-frames may be reduced gradually. In the related art, one frame may include a plurality of time-sequential sub-frames; however, in the above description, the brightness may be differentiated according to the sub-frames, and thus, more grayscales may be represented.

For example, in the AMOLED display according to example embodiments, the current supply to the OLED may be variable to realize frames of a relatively large plurality of grayscales in a digital driving mechanism, in which an image of one frame is divided into a plurality of sub-frames. For example, the image of one frame consists of a plurality of sub-frames according to the related art; however, the period of one frame may be divided into the plurality of sub-frames, and thus, the emission period becomes short in order to improve the resolution and the screen becomes dark.

However, according to example embodiments, the brightness of the frame may be differentiated or distinguished as well as dividing the time of the frame (time division), and thus, more grayscales may be represented than those of the related art. In addition, because sub-frames having higher brightness than those of the related art are realized, lengths of the sub-frames may be reduced, and accordingly, more sub-frames may be added in the frame and high resolution images may be realized.

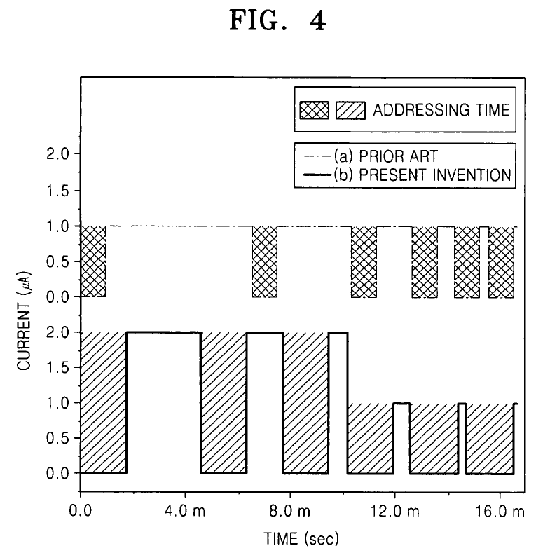

FIG. 4 is a graph of time versus OLED current for explaining methods of representing a sub-frame in a display of an image, the grayscale of which may be about 6 bits and a frame of which may have a period of about 16 ms, according to the related art and example embodiments. According to the related art, a current of about 1 μA flows in each of the sub-frames. According to example embodiments, a current of about 2 μA flows in the first to third sub-frames, and a current of about 1 μA flows in the fourth to sixth sub-frames.

When the frame of example embodiments and the frame of the related art show the same brightness, some of the sub-frames according to the example embodiments may realize about twice the brightness of the related art due to the relatively high currents. Therefore, the lengths of the corresponding sub-frames may be reduced. Because the emission periods of the sub-frames are reduced, the addressing periods in the sub-frames may be increased. As described above, when the addressing periods increase, the addressing of a plurality of pixels may be performed. For example, the currents flowing in some of the sub-frames may be increased to reduce the emission periods, and many pixels may be addressed according to example embodiments.

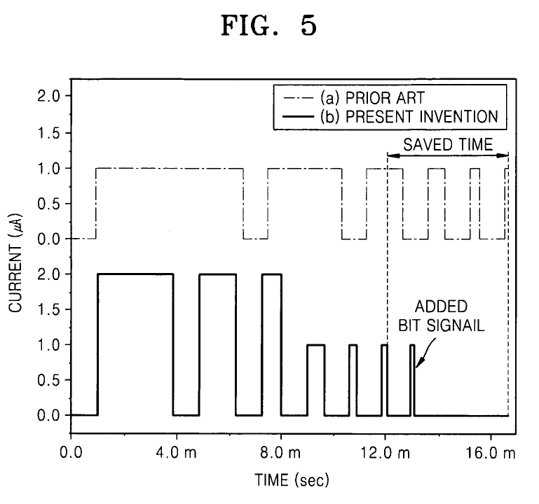

FIG. 5 is a graph of time versus OLED current for explaining realization of greater grayscale in realizing a display of the same brightness and the same resolution in the related art as in example embodiments. Referring to FIG. 5, the length of addressing periods of example embodiments and the related art may be the same. However, in example embodiments, the OLED current may be about 2 μA, twice that of the related art in some sub-frames, for example, first to third sub-frames, and the lengths of the sub-frames may be less than those of the related art. As described above, when the six sub-frames are displayed, example embodiments may display one frame in a shorter time period than the related art, and may have the saved time period. In example embodiments, one or more added bit signals for additional sub-frames may be inserted in the saved time period, and as a result, rich-color images may be represented by the high grayscale.

The structure of FIG. 1 described with reference to the above example embodiments, for example, the pixel circuit of the AMOLED display, according to example embodiments, may include one or more additional current control transistors. The current control transistors may control the amount of current flowing to the OLED, the fixed gate bias voltage may be applied to one or more of the current control transistors and the dynamic gate bias voltages may be applied to the other current control transistors. The gate bias voltages applied to all of the current control transistors may be the same, or may be different according to example embodiments. For example, the gate bias voltages that may be different determine the currents passing through the current control transistors, and as described above, the voltage levels may be the same. Otherwise, the voltage levels may be two or more different levels according to example embodiments.

While example embodiments have been particularly shown and described, it will be understood by one of ordinary skill in the art that variations in form and detail may be made therein without departing from the spirit and scope of the claims.

What is claimed is:

1. An active matrix organic light emitting diode (AMOLED) display comprising:
an organic light emitting diode (OLED);
a driving transistor to switch a current supplied to the OLED based on image signals; and
at least one current controller including a plurality of current control transistors controlling the amount of the current supplied to the OLED.

2. The AMOLED display of claim 1, further comprising:
a storage capacitor storing the image signals; and
a switching transistor storing the image signals in the storage capacitor.

3. The AMOLED display of claim 1, wherein the driving transistor operates in a linear region, and the plurality of current control transistors operate in a saturation region.

4. The AMOLED display of claim 1, wherein a fixed bias voltage is applied to a gate of at least one of the plurality of current control transistors.

5. The AMOLED display of claim 4, wherein a dynamic bias voltage is applied to a gate of at least one of the plurality of current control transistors.

6. The AMOLED display of claim 1, wherein a dynamic bias voltage is applied to a gate of at least one of the plurality of current control transistors.

7. The AMOLED display of claim 5, wherein the at least one current controller further comprises:
a first current control transistor to which the fixed gate bias voltage is applied; and
a second current control transistor to which the dynamic gate bias voltage is applied.

8. The AMOLED display of claim 7, wherein the first and second current control transistors operate in the saturation region, and the driving transistor operates in the linear region.

9. The AMOLED display of claim 7, further comprising:
a storage capacitor storing the image signals; and
a switching transistor storing the image signals in the storage capacitor.

10. The AMOLED display of claim 9, wherein the switching transistor, the driving transistor, and the first and second current control transistors include p-type transistors.

11. A method of driving an AMOLED display, the method comprising:
displaying a main frame of an image by representing a plurality of sub-frames chronologically using an OLED in the AMOLED display,
wherein the main frame includes a plurality of sub-frames having at least two brightness levels.

12. The method of claim 11, wherein forming the plurality of sub-frames comprises:
providing at least one sub-frame of higher brightness; and
providing at least one sub-frame of lower brightness to the brightness of the at least one sub-frame of higher brightness,
wherein the at least one sub-frame of higher brightness is driven before the at least one sub-frame of lower brightness.

13. The method of claim 11, wherein the at least two brightness levels are determined by the current of the OLED displaying the plurality of sub-frames in the AMOLED.

14. The method of claim 11, wherein forming the AMOLED display comprises:
providing a storage capacitor;
forming a switching transistor storing image information in the storage capacitor;
forming a driving transistor to switch a current supplied to the OLED based on the image information in the storage capacitor; and
forming at least one current controller including a plurality of current control transistors controlling the amount of the current supplied to the OLED by the driving transistor,
wherein representing the plurality of sub-frames includes:
recording image information in the storage capacitor by using scan signals and data signals;
operating the driving transistor based on the image information in the storage capacitor to turn on/turn off the current flowing through the OLED; and
controlling the OLED to emit light by controlling the current flowing through the OLED using a plurality of current control transistors between the driving transistor and the OLED.

15. The method of claim 14, wherein the at least one current controller includes a first and a second current control transistor, a fixed gate bias voltage is applied to a gate of the first current control transistor and a dynamic gate bias voltage is applied to a gate of the second current control transistor.

16. The method of claim 14, wherein the first and second current control transistors operate in a saturation region.

17. The method of claim 16, wherein the driving transistor operates in a linear region.
